(19) United States
(12) Patent Application Publication
(10) Pub. No.: US 2024/0273732 A1
(43) Pub. Date: Aug. 15, 2024

(54) METHOD, APPARATUS, COMPUTER DEVICE AND STORAGE MEDIUM FOR IMAGE DISPLAY

(71) Applicant: Beijing Bytedance Network Technology Co., Ltd., Beijing (CN)

(72) Inventor: Yuxing Liu, Beijing (CN)

(21) Appl. No.: 18/567,643

(22) PCT Filed: Oct. 13, 2022
(86) PCT No.: PCT/CN2022/125139

§ 371 Date: Dec. 6, 2023

(30) Foreign Application Priority Data
Nov. 19, 2021 (CN) 202111409329.X

(51) Int. Cl. G06T 7/194; G06T 7/20

(52) U.S. Cl. CPC G06T 7/194; G06T 7/20

(57) ABSTRACT

The disclosure provides a method, apparatus, computer device and storage medium for image display, wherein the method includes: obtaining preview information corresponding to a plurality of multimedia contents, wherein the preview information includes a plurality of superimposed displayed images; presenting a plurality of content cards on a target page, wherein the preview information is displayed on the content cards; in response to a triggering operation on the target page, determining, based on the triggering operation, movement information corresponding to respective images in the preview information in the respective content cards; and controlling the respective images to be moved based on the corresponding movement information in the respective content cards, while controlling the content cards to be moved based on the triggering operation.

### CROSS REFERENCE TO RELATED APPLICATION(S)

The present disclosure claims priority to Chinese Patent Application No. 202111409329.X, filed on Nov. 19, 2021 and entitled “METHOD, APPARATUS, COMPUTER DEVICE AND STORAGE MEDIUM FOR IMAGE DISPLAY”, the contents of which are hereby incorporated by reference in its entirely.

### FIELD

The present disclosure relates to the field of computer technology, and more particularly, to a method, apparatus, computer device, storage medium, computer program product and program for image display.

### BACKGROUND

Currently, with the continuous development of Internet products, more and more people are beginning to use Internet products, such as using mobile applications (APPs) or personal computer (PC) webpages to browse related information.

When displaying search results or recommended information to users, preview information of the search results or recommended information is usually displayed in the form of images, text, and videos. However, this display form is more common, so how to enrich the display form of contents has become an urgent problem to be solved.

### SUMMARY

Embodiments of the present disclosure provide at least one method, apparatus, computer device, storage medium, computer program product and program for image display.

In a first aspect, embodiments of the present disclosure provide a method for image display comprising:
obtaining preview information corresponding to a plurality of multimedia contents, wherein the preview information comprises a plurality of superimposed displayed images;
presenting a plurality of content cards on a target page, wherein the preview information is displayed on the content cards;
in response to a triggering operation on the target page, determining, based on the triggering operation, movement information corresponding to respective images in the preview information in the respective content cards; and
controlling the respective images to be moved based on the corresponding movement information in the respective content cards, while controlling the content cards to be moved based on the triggering operation.

In one possible implementation, the preview information comprises a background image and at least one foreground image; wherein the at least one foreground image is superimposed on the background image, and the at least one foreground image is superimposed in a predetermined hierarchical order.

In one possible implementation, the determining, based on the triggering operation, movement information corresponding to respective images in the preview information in the respective content cards comprises:
determining a first movement distance corresponding to the triggering operation; and
for the respective images in the preview information, determining second movement distances corresponding to the respective images based on movement distance calculation modes corresponding to the respective images and the first movement distance.

In one possible implementation, the determining, based on the triggering operation, movement information corresponding to respective images in the preview information in the respective content cards comprises:
determining, based on a triggering direction of the triggering operation, movement directions corresponding to the respective images; and
the controlling the respective images to be moved based on the corresponding movement information in the respective content cards comprises:
determining a movement time corresponding to the triggering operation;
determining movement speeds corresponding to the respective images based on the movement directions corresponding to the respective images and the movement time; and
controlling, based on the corresponding movement speeds and movement directions, the respective images to be moved for the corresponding movement distances in the respective content cards simultaneously.

In one possible implementation, the determining, based on a triggering direction of the triggering operation, movement directions corresponding to the respective images comprises:
determining property information corresponding to the respective images; and
determining the movement directions corresponding to the respective images based on the triggering direction of the triggering operation and the property information corresponding to the respective images.

In one possible implementation, the determining, based on a triggering direction of the triggering operation, movement directions corresponding to the respective images comprises:
determining property information corresponding to the respective images; and
determining the movement directions corresponding to the respective images based on the triggering direction of the triggering operation and the property information corresponding to the respective images.

In one possible implementation, the plurality of content cards comprise a plurality of target content cards, with an association relationship among the multimedia contents corresponding to the plurality of target content cards, and the plurality of target content cards being adjacent to each other in the target page;
the plurality of target content cards contain a same target foreground image;
target foreground images in the preview information displayed in the plurality of target content cards are region images of different regions of the target foreground image; and
the region images displayed in two adjacent target content cards are adjacent to each other in the target foreground image.

In one possible implementation, the determining, based on the triggering operation, movement information corresponding to respective images in the preview information in the respective content cards comprises:
for any of the target content cards,
determining, based on region information of the target foreground image corresponding to the target content card and the triggering operation, foreground movement information corresponding to the target content card, and determining based on the triggering operation, background movement information corresponding to a background image of the target content card; and
wherein the foreground movement information of two adjacent target content cards is the same.

In one possible implementation, in accordance with a determination that the preview information displayed in any of the content cards comprises a dynamic image, the method further comprises:
playing the dynamic image, while moving the content card to a target position region of a screen interface.

In a second aspect, embodiments of the present disclosure further provide an apparatus for image display, comprising:
an obtaining module configured to obtain preview information corresponding to a plurality of multimedia contents, wherein the preview information comprises a plurality of superimposed displayed images;
a presenting module configured to present a plurality of content cards on a target page, wherein the preview information is displayed on the content cards;
a response module configured to, in response to a triggering operation on the target page, determine, based on the triggering operation, movement information corresponding to respective images in the preview information in the respective content cards; and
a control module configured to control the respective images to be moved based on the corresponding movement information in the respective content cards, while controlling the content cards to be moved based on the triggering operation.

In one possible implementation, the preview information comprises a background image and at least one foreground image; wherein the at least one foreground image is superimposed on the background image, and the at least one foreground image is superimposed in a predetermined hierarchical order.

In one possible implementation, the response module, when determining, based on the triggering operation, movement information corresponding to respective images in the preview information in the respective content cards, is configured to:
determine a first movement distance corresponding to the triggering operation; and
for the respective images in the preview information, determine second movement distances corresponding to the respective images based on movement distance calculation modes corresponding to the respective images and the first movement distance.

In one possible implementation, the response module, when determining, based on the triggering operation, movement information corresponding to respective images in the preview information in the respective content cards, is configured to:
determine, based on a triggering direction of the triggering operation, movement directions corresponding to the respective images; and
the control module, when controlling the respective images to be moved based on the corresponding movement information in the respective content cards, is configured to:
determine a movement time corresponding to the triggering operation;
determine movement speeds corresponding to the respective images based on the movement directions corresponding to the respective images and the movement time; and
control, based on the corresponding movement speeds and movement directions, the respective images to be moved for the corresponding movement distances in the respective content cards simultaneously.

In one possible implementation, the response module, when determining, based on a triggering direction of the triggering operation, movement directions corresponding to the respective images, is configured to:
determine property information corresponding to the respective images; and
determine the movement directions corresponding to the respective images based on the triggering direction of the triggering operation and the property information corresponding to the respective images.

In one possible implementation, the plurality of content cards comprise a plurality of target content cards, with an association relationship among the multimedia contents corresponding to the plurality of target content cards, and the plurality of target content cards being adjacent to each other in the target page;
the plurality of target content cards contain a same target foreground image;
target foreground images in the preview information displayed in the plurality of target content cards are region images of different regions of the target foreground image; and
the region images displayed in two adjacent target content cards are adjacent to each other in the target foreground image.

In one possible implementation, the response module, when determining, based on the triggering operation, movement information corresponding to respective images in the preview information in the respective content cards, is configured to:
for any of the target content cards,
determine, based on region information of the target foreground image corresponding to the target content card and the triggering operation, foreground movement information corresponding to the target content card, and determine based on the triggering operation, background movement information corresponding to a background image of the target content card; and
wherein the foreground movement information of two adjacent target content cards is the same.

In one possible implementation, the control module, in accordance with a determination that the preview information displayed in any of the content cards comprises a dynamic image, is further configured to:
play the dynamic image, while moving the content card to a target position region of a screen interface.

In a third aspect, embodiments of the present disclosure also provide a computer device, comprising: a processor, a memory, and a bus, the memory having machine-readable instructions stored thereon which are executable by the processor, wherein the processor communicate with the memory through the bus when the computer device is running, and the machine-readable instructions, when executed by the processor, perform the above first aspect or the steps of any of the possible implementations of the first aspect.

In a fourth aspect, embodiments of the present disclosure further provide a computer-readable storage medium, wherein the computer-readable storage medium has a computer program stored thereon that, when executed by a processor, performs the above first aspect or the steps of any of the possible implementations of the first aspect.

In a fifth aspect, embodiments of the present disclosure further provide a computer program product comprising a computer program that, when executed by a processor, performs the above first aspect or the steps of any of the possible implementations of the first aspect.

In a sixth aspect, embodiments of the present disclosure further provide computer program, wherein the computer program, when executed by a processor, performs the above first aspect or the steps of any of the possible implementations of the first aspect.

The present disclosure provides a method, apparatus, computer device and a storage medium for image display, wherein preview information corresponding to a plurality of multimedia contents is obtained first and a plurality of content cards is presented on a target page, wherein the preview information is displayed on the content cards; and then in response to a triggering operation on the target page, movement information corresponding to respective images in the preview information in the respective content cards is determined based on the triggering operation; and the respective images is controlled to be moved based on the corresponding movement information in the respective content cards, while controlling the content cards to be moved based on the triggering operation. By adopting this method, the present effect of the preview information can be transformed with the user's triggering operation, and static images are presented with dynamic effects, increasing the user's interest in reading preview information.

In order to make the above objectives, features, and advantages of this disclosure more apparent and understandable, the following provides preferred embodiments, and provides a detailed explanation as follows in conjunction with the accompanying drawings.

### BRIEF DESCRIPTION OF DRAWINGS

In order to more clearly illustrate technical solutions of the embodiments of the present disclosure, accompanying drawings that need to be used in the embodiments will be briefly introduced below. The drawings here are incorporated into the specification and constitute a part of this specification. These drawings illustrate the technical solutions that conform to the embodiments of the present disclosure and are used together with the specification to illustrate the technical solutions of the present disclosure. It should be understood that the following drawings only illustrate certain embodiments of the present disclosure and should not be regarded as limiting the scope. For those skilled in the art, without creative labor, other related drawings can be obtained based on these drawings.

FIG. 1 shows a flowchart of a method for image display provided in the embodiments of the present disclosure;

FIG. 2 shows a schematic diagram of display effects of a plurality of foreground images provided in the embodiments of the present disclosure;

FIG. 3 shows a schematic diagram of an image displayed in a content card provided in the embodiments of the present disclosure;

FIG. 4 shows a schematic diagram of a content card and respective image movement provided in the embodiments of the present disclosure;

FIG. 5a shows a schematic diagram of region division for a target foreground image provided in the embodiments of the present disclosure;

FIG. 5b shows a schematic diagram of region images displayed in a target content card provided in the embodiments of the present disclosure;

FIG. 6 shows a schematic diagram of an architecture of an apparatus for image display provided in the embodiments of the present disclosure;

FIG. 7 shows a structural schematic diagram of a computer device provided in the embodiments of the present disclosure.

### DETAILED DESCRIPTION

In order to make the purpose, technical solutions, and advantages of the embodiments of the present disclosure clearer, the technical solutions in the embodiments of the present disclosure will be described clearly and completely in conjunction with the accompanying drawings below. Apparently, the described embodiments are only part of the embodiments of the present disclosure, not all of them. The components of the embodiments of the present disclosure described and shown in the drawings can be arranged and designed in various configurations. Therefore, the following detailed description of the embodiments of the present disclosure provided in the drawings is not intended to limit the scope of the claimed disclosure, but only represents selected embodiments of the present disclosure. Based on the embodiments of the present disclosure, all other embodiments obtained by those skilled in the art without creative labor belong to the scope of protection of the present disclosure.

Currently, with the continuous development of Internet products, more and more people are beginning to use Internet products, such as using mobile applications (APPs) or personal computer (PC) webpages to browse related information.

When displaying search results or recommended information to users, preview information of the search results or recommended information is usually displayed in the form of images, text, and videos. However, this display form is more common, so how to enrich the display form of contents has become an urgent problem to be solved.

Based on the above research, the present disclosure provides a method, apparatus, computer device and a storage medium for image display, wherein preview information corresponding to a plurality of multimedia contents is obtained first and a plurality of content cards is presented on a target page, wherein the preview information is displayed on the content cards; and then in response to a triggering operation on the target page, movement information corresponding to respective images in the preview information in the respective content cards is determined based on the triggering operation; and the respective images is controlled to be moved based on the corresponding movement information in the respective content cards, while controlling the content cards to be moved based on the triggering operation. By adopting this method, the present effect of the preview information can be transformed with the user's triggering operation, and static images are presented with dynamic effects, increasing the user's interest in reading preview information.

It should be noted that similar numbers and letters represent similar items in the following figures, so once an item is defined in one figure, it does not need to be further defined and explained in subsequent figures.

The term “and/or” in this article only describes an association relationship, indicating that there can be three types of relationships, for example, A and/or B, which can mean: A exists alone, A and B exist simultaneously, and B exists alone. In addition, the term “at least one” in this article means any combination of any one or at least two of the plurality of, for example, including at least one of A, B, and C, and can mean any one or more elements selected from the set comprising A, B, and C.

In order to facilitate understanding of the embodiments of the predetermined disclosure, first of all, a method for image display disclosed in the embodiments of the present disclosure is described in detail. The execution actor of the method for image display provided in the embodiments of the present disclosure is generally a terminal device, which can be a smart phone, a tablet, a personal computer, and the like.

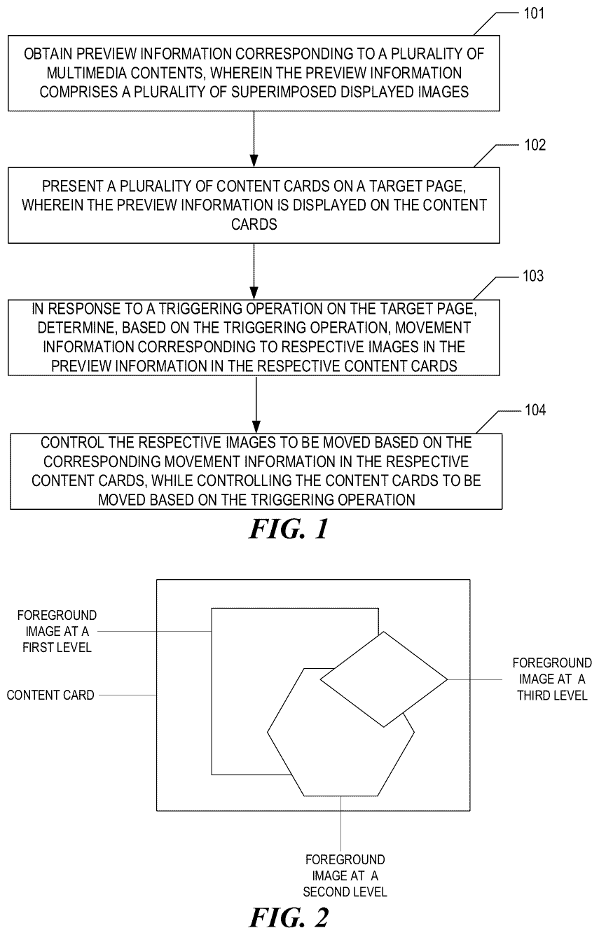

Referring to FIG. 1, a flowchart of a method for image display provided in the embodiments of the present disclosure is shown, the method comprising steps 101 to 104, wherein:

Step 101, obtaining preview information corresponding to a plurality of multimedia contents, wherein the preview information comprises a plurality of superimposed displayed images;

Step 102, presenting a plurality of content cards on a target page, wherein the preview information is displayed on the content cards;

Step 103, in response to a triggering operation on the target page, determining, based on the triggering operation, movement information corresponding to respective images in the preview information in the respective content cards; and

Step 104, controlling the respective images to be moved based on the corresponding movement information in the respective content cards, while controlling the content cards to be moved based on the triggering operation.

The following is a detailed explanation of the above steps:

For step 101, in one possible scenario, the multimedia contents can be recommended content, such as recommended contents in a feed streaming scenario; or in another possible scenario, the multimedia contents can be search results. After a user initiates a search request, preview information corresponding to the plurality of multimedia contents for the search request is displayed on a user side.

The type of the multimedia contents may include images, text, videos, audios, and the type of the preview information for the multimedia contents may be the same as the type of the multimedia contents, for example images, text, dynamic images, audios, etc. By way of example, if the multimedia contents are a plurality of recommended comics, the preview information may be covers of the plurality of comics.

In one possible implementation, the preview information comprises a background image and at least one foreground image; wherein the at least one foreground image is superimposed on the background image, and the at least one foreground image is superimposed in a predetermined hierarchical order.

The foreground images may include entity images, such as images containing people, animals, flowers, insects, etc., or may be scene images, such as mountains, rivers, etc., or may be an image of other content such as art images, solid color images, etc. The background image may also include the scene image, the entity image, and the image of other content. Herein, the foreground images and the background image are not distinguished in terms of image contents.

Specifically, the background image is located at the lowest level of the preview information; and if the preview information contains a plurality of foreground images, the plurality of foreground images may be located at different predetermined levels, respectively. By way of example, as shown in FIG. 2, the preview information contains three foreground images, and the three foreground images are located at the first level, the second level, and the third level from the lowest predetermined level to the highest predetermined level, respectively. In the plurality of foreground images, there may also be some foreground images located at the same predetermined level. By way of example, the preview information contains five foreground images, and the five foreground images are located at the first level, the second level, the second level, the third level, and the fourth level in the order from the lowest predetermined level to the highest predetermined level.

Herein, the foreground image located at the same predetermined level cannot overlap with each other. For an overlap region between every two foreground images located at different predetermined levels, only the foreground image of the overlap region located at a predetermined higher level is displayed.

Hierarchizing the plurality of foreground images can better reflect the order of the plurality of foreground images, thereby enhancing the spatial sense of the displayed preview information.

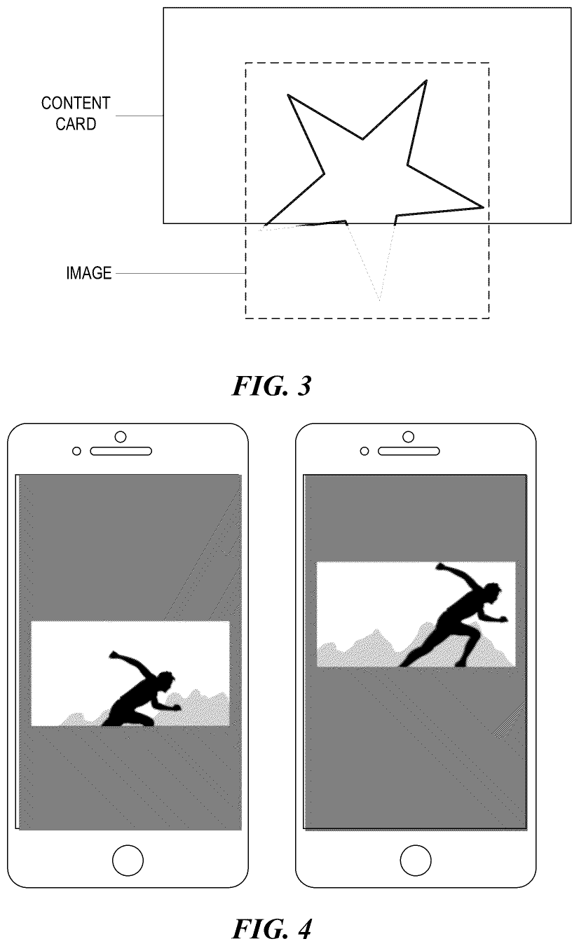

For step 102, wherein the target page can be used to present a plurality of content cards; the shape of the content card can be any shape, such as polygons, circles, irregular graphics, etc. Various display forms can be adopted for the plurality of content cards, such as a separate display form, a cross display form, a flat display form, a stereoscopic display form, etc. The preview information can be displayed in a region range of a respective content card, and a plurality of images in the preview information can be fully displayed in the content cards, or as shown in FIG. 3, only part of the image within the region range of the content card can be displayed.

It should be noted that the size of the background image in the preview information herein is generally larger than the size of the content cards, and the size of the foreground images is smaller than the size of the content cards.

For step 103, wherein the triggering operation may include a sliding operation in various directions, or the triggering operation may be a voice operation, a gesture operation, etc. For example, the voice operation may be a speech information indicating a direction word, such as “up”, “down”, “next”, and the voice operation may also be a speech information containing a title of the multimedia content corresponding to any of the displayed preview information (if the title is located at the bottom of the target page, the voice operation is used to direct the target page to be moved up). The gesture operation may be a predetermined gesture- for example, waving up can direct a page to be moved up, and waving down can direct the page to be moved down, etc.

The movement information may include, for example, a movement direction and/or movement distance. The movement information corresponding to different images in the same preview information may be different.

In one possible implementation, when determining, based on the triggering operation, movement information corresponding to respective images in the preview information in the respective content cards, a first movement distance corresponding to the triggering operation can be determined first; and for the respective images in the preview information, second movement distances corresponding to the respective images are determined based on movement distance calculation modes corresponding to the respective images and the first movement distance.

Specifically, when determining the first movement distance, if the triggering operation is a sliding operation directed to any direction, the first movement distance may be a sliding distance of the sliding operation, or the first movement distance may be a distance calculated based on the sliding distance; and if the triggering operation is a voice operation, the first movement distance may be a predetermined distance that the target page travels.

By way of example, when determining the second movement distance, if the first movement distance is 100 pixels in length and the movement distance calculation mode is that the second movement distance is twice the first movement distance, the second movement distance is 200 pixels in length.

It should be noted that the movement distance calculation modes corresponding different images may be different. By way of example, when the target page is slid, the foreground image may move faster, and the background image may move slower, so different images can be set with different distance calculation modes based on a parallax effect and an actual situation.

For example, if the background image contained in the preview information is a mountain image and the contained two foreground images are a car image and a forest image respectively, the second movement distance for the mountain image can be set to be 0.5 times the first movement distance, the second movement distance for the car image can be set to be 2 times the first movement distance, and the second movement distance for the forest image can be set to be 1.2 times the first movement distance. In this way, the visual effect is presented that the distant mountain moves slower, while the nearby forest moves faster during the driving process of the car.

By using this method, different images in the preview information can travel different distances, thereby producing a parallax effect and enhancing the fun of browsing the preview information.

In one possible implementation, when determining, based on the triggering operation, movement information corresponding to respective images in the preview information in the respective content cards comprises, movement directions corresponding to the respective images can be determined based on a triggering direction of the triggering operation.

The movement directions corresponding to the respective images herein comprises a linear direction (e.g., towards the left, downward, towards a 45 degree) and a curved direction (e.g., arc, wavy line).

Specifically, when determining the movement directions corresponding to the respective images, if the triggering operation is a sliding operation, it is necessary to first determine the sliding direction of the sliding operation (i.e., the triggering direction), and then determine the movement directions corresponding to the respective images based on the predetermined relationship between the sliding direction and the movement directions corresponding to the respective images.

For example, if the preview information contains two images, namely a first image and a second image, and the direction relationship corresponding to the first image is the same as the sliding direction, and the direction relationship corresponding to the second image is opposite to the sliding direction, the movement direction corresponding to the first image is right, and the movement direction corresponding to the second image is left when the sliding direction is right.

If the triggering operation is a voice operation, the triggering direction of the voice operation may be the direction indicated by a direction term contained in the voice operation. If the voice operation is “swipe left”, the triggering direction of the voice operation may be left.

For the triggering operation with different triggering directions, any image herein may correspond to a plurality of different movement directions. For example, when the target page responses to a sliding up operation, a third image in the preview information is slid to the left, and when the target page responses to a sliding down operation, the third image in the preview information is slid to the right.

By moving different images in different directions, the preview information is more vividly displayed, increasing the interest of browsing the preview information.

In another possible implementation, when determining, based on a triggering direction of the triggering operation, movement directions corresponding to the respective images, property information corresponding to the respective images is determined first; and the movement directions corresponding to the respective images is determined based on the triggering direction of the triggering operation and the property information corresponding to the respective images.

Specifically, the property information may be a category of an object—such as the category of an apple tree, a pear tree is a tree, and the category of a football, a basketball is a ball. When the movement directions corresponding to the respective images is determined based on the triggering direction of the triggering operation and the property information corresponding to the respective images, the determination may be based on the nature of the property information. For example, if the property information of the first image in the preview information is a ball, and the movement direction of the triggering operation is left, the movement direction corresponding to the first image may be a parabolic direction to the left; and if the property of the second image in the preview information is a bird, and the movement direction of the triggering operation is the right, the movement direction corresponding to the second image may be a upright direction at a 45 degree angle from the horizontal.

For step 104, by way of example, the content card and moving pictures of the respective images may be as shown in FIG. 4. The content card is being moved upward, a human image in the content card is being moved in the upright direction, and a mountain image in the content card being moved to the left.

In one possible implementation, when controlling the respective images to be moved based on the corresponding movement information in the respective content cards, a movement time corresponding to the triggering operation can be determined first; and movement speeds corresponding to the respective images can be determined based on the movement directions corresponding to the respective images (the movement information includes the movement distance) and the movement time; and lastly, the respective images are controlled to be moved for the corresponding movement distances in the respective content cards simultaneously based on the corresponding movement speeds and movement directions.

The movement time corresponding to the triggering operation herein may be the duration during which the triggering operation is performed, such as the total duration during which a single sliding operation is performed; or the movement time may refer to the time required for the page to move from start to end. By way of example, the movement speed may be determined by dividing the movement distance by the movement time.

By way of example, if the user slides down on the touch screen for 2 seconds and the movement distance corresponding to the first image in the preview information is 3 cm, the movement time corresponding to the triggering operation is 2 seconds, and the movement speed corresponding to the first image is 1.5 cm/sec; and if the movement direction corresponding to the first image is the right, the first image is slid to the right at a speed of 1.5 cm/sec to travel 3 cm.

In another possible implementation, property information corresponding to the respective images can be determined first; the movement directions corresponding to the respective images can be determined based on the property information; and lastly, the respective images are controlled to be moved for the corresponding movement distances in the respective content cards simultaneously based on the corresponding movement speeds and movement directions.

By way of example, if the property information of the second image in the preview information is a ball, the movement direction of the second image is a parabolic direction. The movement speed of the second image can first slow down and then increase based on the predetermined movement speed, making the physical effect of the displayed second image more realistic.

In one possible application scenario, for a plurality of target content cards for which the displayed preview information has association relationship, a same target foreground image, as well as a plurality of other different foreground images and different background images can be displayed in the plurality of target content cards, in order to present the dynamic effect that the same object is moving in the plurality of target content cards. The specific execution method is as follows:

In one possible implementation, the plurality of content cards comprise a plurality of target content cards, with an association relationship among the multimedia contents corresponding to the plurality of target content cards, and the plurality of target content cards being adjacent to each other in the target page; the plurality of target content cards contain a same target foreground image; target foreground images in the preview information displayed in the plurality of target content cards are region images of different regions of the target foreground image; and the region images displayed in two adjacent target content cards are adjacent to each other in the target foreground image.

Specifically, the association relationship can be that the multimedia contents corresponding to the plurality of target content cards have a same theme or belongs to different parts of a same object. For example, the multimedia contents corresponding to the plurality of target content cards respectively are different chapters of a same comic.

It should be noted that the meaning of the plurality of target content cards containing a same target foreground image herein is that each of the target content cards contains the target foreground image. In addition to the target foreground image, each of the target content card may also include other foreground images in addition to the target foreground image.

For example, if the target content card includes a content card 1, a content card 2, and a content card 3, the content card 1 includes a foreground image 1, the content card 2 includes a foreground image 1, and the content card 3 also includes a foreground image 1.

It should be noted that in the preview information displayed in the content cards 1, 2, and 3, the displayed foreground images are different regions of the foreground image 1. For example, the preview information displayed in the content card 1 includes a region A of the foreground image 1, the preview information displayed in the content card 2 includes a region B of the foreground image 1, and the preview information displayed in the content card 3 includes a region C of the foreground image 1.

The region images displayed in two adjacent target content cards are adjacent to each other in the target foreground image. For example, if the content card 1 and the content card 2 are adjacent, the region A and the region B are adjacent to each other in the foreground image 1. If the content card 2 and the content card 3 are adjacent, the region B and the region C are adjacent to each other in the foreground image 1.

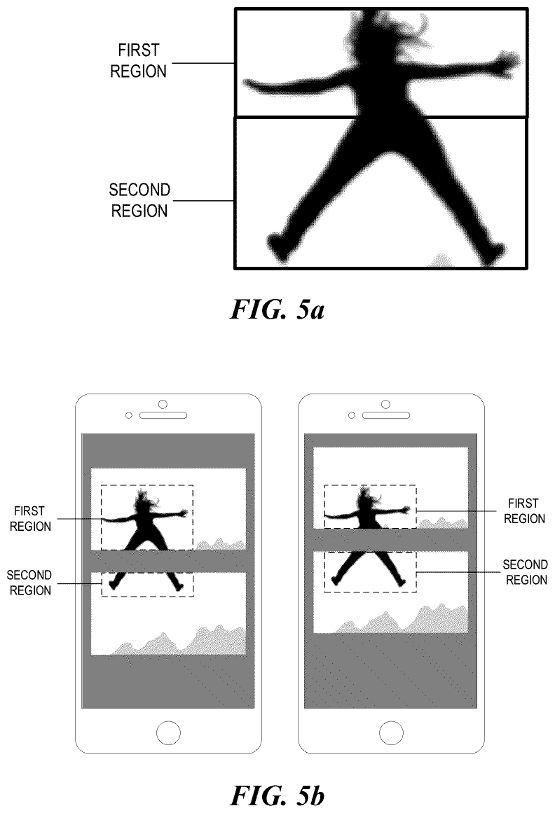

By way of example, as shown in FIG. 5a, the first target content card displays a region image of the first region of the target foreground image, and the second target content card displays a region image of the second region of the target foreground image. The region image of the first region and the region image of the second region are adjacent to each other in the target foreground image.

In one possible implementation, when determining, based on the triggering operation, movement information corresponding to respective images in the preview information in the respective content cards, for any of the target content cards, foreground movement information corresponding to the target content card is determined based on region information of the target foreground image corresponding to the target content card and the triggering operation, and background movement information corresponding to a background image of the target content card is determined based on the triggering operation; wherein the foreground movement information of two adjacent target content cards is the same.

The region information of the target foreground images corresponding to the target content cards herein can be position information of the region image in the preview information displayed in the target content cards in the target foreground image. For any of the target content cards, the size of the region image may change during the movement of the corresponding region image.

By way of example, as shown in FIG. 5b, when the target content cards and the target foreground images are being moved downward, the size of the first region and the size of the second region will change as the target foreground image moves.

In this way, the display effect can be achieved that the same target foreground image is being moved between the plurality of different target content cards, greatly improving the fun of displaying the recommended information and search results.

In one possible implementation, in accordance with a determination that the preview information displayed in any of the content cards comprises a dynamic image, the method further comprises: playing the dynamic image, while moving the content card to a target position region of a screen interface.

By way of example, the preview information displayed in any of the content cards may include both a static image and a dynamic image. In response to a triggering operation on the target page, the content cards and the respective images in the content cards are controlled to move based on the respective movement information. When the content cards are moved to the target position region of the screen interface, the dynamic image is played. In addition, it is possible to make display pictures of the respective images consistent with an initial picture of the dynamic image when the content cards are moved to the target position region of the screen interface, so that the user's viewing experience is smoother.

In a method for image display provided in embodiments of the present disclosure, preview information corresponding to a plurality of multimedia contents is obtained first and a plurality of content cards is presented on a target page, wherein the preview information is displayed on the content cards; and then in response to a triggering operation on the target page, movement information corresponding to respective images in the preview information in the respective content cards is determined based on the triggering operation; and the respective images is controlled to be moved based on the corresponding movement information in the respective content cards, while controlling the content cards to be moved based on the triggering operation. By adopting this method, the present effect of the preview information can be transformed with the user's triggering operation, and static images are presented with dynamic effects, increasing the user's interest in reading preview information.

Those skilled in the art will appreciate that, in the above method in the detailed description, the writing order of the respective steps does not mean a strict performance order and constitute any limitation on the implementation process, the specific performance order of the respective steps should be determined by its function and possible internal logic.

Based on the same inventive concept, embodiments of the present disclosure also provide an apparatus for image display corresponding to the method for image display. Since the principle of the apparatus in the embodiments of the present disclosure to solve the problem is similar to the method for image display in the above embodiments of the present disclosure, the implementation of the apparatus may refer to the implementation of the method, which will not be repeated herein.

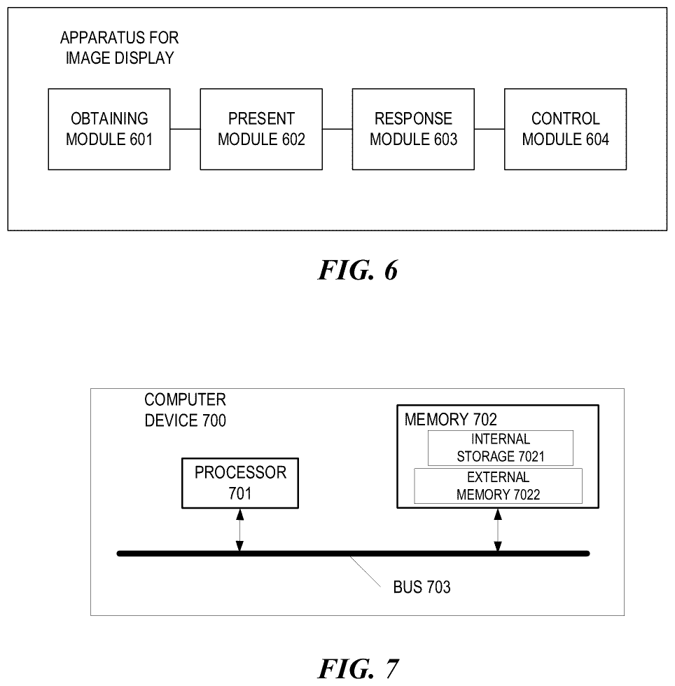

Referring to FIG. 6, a schematic diagram of an architecture of an apparatus for image display provided in the embodiments of the present disclosure is shown, the apparatus comprising an obtaining module 601, a present module 602, a response module 603, and a control module 604; wherein, the obtaining module 601 configured to obtain preview information corresponding to a plurality of multimedia contents, wherein the preview information comprises a plurality of superimposed displayed images; the presenting module 602 configured to present a plurality of content cards on a target page, wherein the preview information is displayed on the content cards; the response module 603 configured to, in response to a triggering operation on the target page, determine, based on the triggering operation, movement information corresponding to respective images in the preview information in the respective content cards; and the control module 604 configured to control the respective images to be moved based on the corresponding movement information in the respective content cards, while controlling the content cards to be moved based on the triggering operation.

In one possible implementation, the preview information comprises a background image and at least one foreground image; wherein the at least one foreground image is superimposed on the background image, and the at least one foreground image is superimposed in a predetermined hierarchical order.

In one possible implementation, the response module 603, when determining, based on the triggering operation, movement information corresponding to respective images in the preview information in the respective content cards, is configured to determine a first movement distance corresponding to the triggering operation; and for the respective images in the preview information, determine second movement distances corresponding to the respective images based on movement distance calculation modes corresponding to the respective images and the first movement distance.

In one possible implementation, the response module 603, when determining, based on the triggering operation, movement information corresponding to respective images in the preview information in the respective content cards, is configured to determine, based on a triggering direction of the triggering operation, movement directions corresponding to the respective images; and the control module 604, when controlling the respective images to be moved based on the corresponding movement information in the respective content cards, is configured to determine a movement time corresponding to the triggering operation; determine movement speeds corresponding to the respective images based on the movement directions corresponding to the respective images and the movement time; and control, based on the corresponding movement speeds and movement directions, the respective images to be moved for the corresponding movement distances in the respective content cards simultaneously.

In one possible implementation, the response module 603, when determining, based on a triggering direction of the triggering operation, movement directions corresponding to the respective images, is configured to determine property information corresponding to the respective images; and determine the movement directions corresponding to the respective images based on the triggering direction of the triggering operation and the property information corresponding to the respective images.

In one possible implementation, the plurality of content cards comprise a plurality of target content cards, with an association relationship among the multimedia contents corresponding to the plurality of target content cards, and the plurality of target content cards being adjacent to each other in the target page; the plurality of target content cards contain a same target foreground image; target foreground images in the preview information displayed in the plurality of target content cards are region images of different regions of the target foreground image; and the region images displayed in two adjacent target content cards are adjacent to each other in the target foreground image.

In one possible implementation, the response module 603, when determining, based on the triggering operation, movement information corresponding to respective images in the preview information in the respective content cards, is configured to: for any of the target content cards, determine, based on region information of the target foreground image corresponding to the target content card and the triggering operation, foreground movement information corresponding to the target content card, and determine based on the triggering operation, background movement information corresponding to a background image of the target content card; and wherein the foreground movement information of two adjacent target content cards is the same.

In one possible implementation, the control module 604, in accordance with a determination that the preview information displayed in any of the content cards comprises a dynamic image, is further configured to: play the dynamic image, while moving the content card to a target position region of a screen interface.

Description of the processing flow of each module in the apparatus, and the interaction flow between the modules may refer to the relevant description of the above method embodiments, not described in detail herein.

Based on the same technical concept, embodiments of the present disclosure further provide a computer device. Referring to FIG. 7, a structural schematic diagram of a computer device 700 provided in the embodiments of the present disclosure is shown, comprising a processor 701, a memory 702, and a bus 703. The memory 702 herein is used to store execution instructions, including internal storage 7021 and external memory 7022. The internal storage 7021, also known as an internal memory herein, is used to temporarily store arithmetic data in the processor 701 and data exchanged with external memory 7022 such as a hard disk. The processor 701 exchanges data with the external memory 7022 through the external storage 7021. When the computer device 700 is running, the processor 701 communicates with the memory 702 through the bus 703, causing the processor 701 to execute the following instructions: obtaining preview information corresponding to a plurality of multimedia contents, wherein the preview information comprises a plurality of superimposed displayed images; presenting a plurality of content cards on a target page, wherein the preview information is displayed on the content cards; in response to a triggering operation on the target page, determining, based on the triggering operation, movement information corresponding to respective images in the preview information in the respective content cards; and controlling the respective images to be moved based on the corresponding movement information in the respective content cards, while controlling the content cards to be moved based on the triggering operation.

In one possible implementation, in the instructions executed by the processor 701, the preview information comprises a background image and at least one foreground image; wherein the at least one foreground image is superimposed on the background image, and the at least one foreground image is superimposed in a predetermined hierarchical order.

In one possible implementation, in the instruction executed by the processor 701, the determining, based on the triggering operation, movement information corresponding to respective images in the preview information in the respective content cards comprises: determining a first movement distance corresponding to the triggering operation; and for the respective images in the preview information, determining second movement distances corresponding to the respective images based on movement distance calculation modes corresponding to the respective images and the first movement distance.

In one possible implementation, in the instruction executed by the processor 701, the determining, based on the triggering operation, movement information corresponding to respective images in the preview information in the respective content cards comprises: determining, based on a triggering direction of the triggering operation, movement directions corresponding to the respective images; and the controlling the respective images to be moved based on the corresponding movement information in the respective content cards comprises: determining a movement time corresponding to the triggering operation; determining movement speeds corresponding to the respective images based on the movement directions corresponding to the respective images and the movement time; and controlling, based on the corresponding movement speeds and movement directions, the respective images to be moved for the corresponding movement distances in the respective content cards simultaneously.

In one possible implementation, in the instruction executed by the processor 701, the determining, based on a triggering direction of the triggering operation, movement directions corresponding to the respective images comprises: determining property information corresponding to the respective images; and determining the movement directions corresponding to the respective images based on the triggering direction of the triggering operation and the property information corresponding to the respective images.

In one possible implementation, in the instructions executed by processor 701, the plurality of content cards comprise a plurality of target content cards, with an association relationship among the multimedia contents corresponding to the plurality of target content cards, and the plurality of target content cards being adjacent to each other in the target page; the plurality of target content cards contain a same target foreground image; target foreground images in the preview information displayed in the plurality of target content cards are region images of different regions of the target foreground image; and the region images displayed in two adjacent target content cards are adjacent to each other in the target foreground image.

In one possible implementation, in the instruction executed by the processor 701, the determining, based on the triggering operation, movement information corresponding to respective images in the preview information in the respective content cards comprises: for any of the target content cards, determining, based on region information of the target foreground image corresponding to the target content card and the triggering operation, foreground movement information corresponding to the target content card, and determining based on the triggering operation, background movement information corresponding to a background image of the target content card; and wherein the foreground movement information of two adjacent target content cards is the same.

In one possible implementation, in the instruction executed by processor 701, in accordance with a determination that the preview information displayed in any of the content cards comprises a dynamic image, the method further comprises: playing the dynamic image, while moving the content card to a target position region of a screen interface.

Embodiments of the present disclosure further provides a computer-readable storage medium having a computer program stored therein, that, when executed by a processor, performs the steps of the method for image display described in the above embodiments. The storage medium herein can be a volatile or non-volatile computer-readable storage medium.

Embodiments of the present disclosure further provides a computer program product that carries program code, the program code comprising instructions that can be used to perform the steps of the image display method described in the above embodiments. The above-described specific method embodiment can be referred to, which will not be described herein again.

Herein, the computer program product described above may be implemented in hardware, software, or a combination thereof. In an optional embodiment, the computer program product is implemented as a computer storage medium, and in another optional embodiment, the computer program product is implemented as a software product, such as a Software Development Kit (SDK) and the like.

Embodiments of the present disclosure further provides a computer program that, when executed by a processor, performs the steps of the image display method described in the above embodiments.

Those skilled in the art may clearly understand that for the convenience and brevity of description, the specific working process of the system and apparatus described above may refer to the corresponding process in the aforementioned method embodiments, which will not be repeated here. In several embodiments provided in this disclosure, it should be understood that the disclosed system, apparatus, and method may be implemented in other ways. The apparatus embodiments described above are only illustrative. For example, the division of the unit is only a logical function division, and there may be other division methods in actual implementation. For another example, a plurality of units or components may be combined or integrated into another system, or some features may be ignored or not executed. Another point is that the coupling or direct coupling or communication connection between the displayed or discussed apparatuses or units may be indirectly coupled or connected through some communication interfaces, apparatuses, or units, which may be electrical, mechanical, or other forms.

The units described as separate components may or may not be physically separated, and the components displayed as units may or may not be physical units, that is, they may be located in one place or may be distributed to a plurality of network units. Some or all of the units may be selected according to actual needs to achieve the purpose of the embodiments of the present disclosure.

Further, the functional units in various embodiments of the present disclosure may be integrated in one processing unit, each unit may be physically present alone, may be two or more units integrated in one unit.

If the function is implemented in the form of a software functional unit and sold or used as an independent product, it may be stored in a non-volatile computer-readable storage medium executable by a processor. Based on this understanding, the technical solution of the present disclosure may be embodied in the form of a software product, which is stored in a storage medium and includes several instructions to make a computer device (which may be a personal computer, a server, or a network device, etc.) perform all or part of the steps of the methods described in each embodiment of the present disclosure. The aforementioned storage medium includes U disk, mobile hard disk, Read-Only Memory (ROM), RandomAccess Memory (RAM), magnetic disk or optical disk, and other medium that may store program code.

Finally, it should be noted that: the above embodiments are only a detailed implementation of the present disclosure, to illustrate the technical solution of the present disclosure, rather than limiting it, the scope of protection of the present disclosure is not limited thereto, although with reference to the foregoing embodiments of the present disclosure has been described in detail, those skilled in the art should understand that: any person skilled in the art in the field within the technical scope of the present disclosure may still modify or easily think of changes to the technical solutions described in the foregoing embodiments, or equivalently replace some of the technical features; and these modifications, changes or substitutions, does not make the essence of the corresponding technical solutions from the spirit and scope of embodiments of the present disclosure, and should be covered within the scope of the present disclosure. Therefore, the scope of the present disclosure should be subject to the scope of the claims.

1. A method for image display, comprising:
obtaining preview information corresponding to a plurality of multimedia contents, wherein the preview information comprises a plurality of superimposed displayed images;
presenting a plurality of content cards on a target page, wherein the preview information is displayed on the content cards;
in response to a triggering operation on the target page, determining, based on the triggering operation, movement information corresponding to respective images in the preview information in the respective content cards; and
controlling the respective images to be moved based on the corresponding movement information in the respective content cards, while controlling the content cards to be moved based on the triggering operation.

2. The method of claim 1, wherein the preview information comprises a background image and at least one foreground image; wherein the at least one foreground image is superimposed on the background image, and the at least one foreground image is superimposed in a predetermined hierarchical order.

3. The method of claim 1, wherein the determining, based on the triggering operation, movement information corresponding to respective images in the preview information in the respective content cards comprises:
determining a first movement distance corresponding to the triggering operation; and
for the respective images in the preview information, determining second movement distances corresponding to the respective images based on movement distance calculation modes corresponding to the respective images and the first movement distance.

4. The method of claim 3, wherein the determining, based on the triggering operation, movement information corresponding to respective images in the preview information in the respective content cards comprises:
determining, based on a triggering direction of the triggering operation, movement directions corresponding to the respective images;
wherein the controlling the respective images to be moved based on the corresponding movement information in the respective content cards comprises:
determining a movement time corresponding to the triggering operation;
determining movement speeds corresponding to the respective images based on the movement directions corresponding to the respective images and the movement time; and
controlling, based on the corresponding movement speeds and movement directions, the respective images to be moved for the corresponding movement distances in the respective content cards simultaneously.

5. The method of claim 4, wherein the determining, based on a triggering direction of the triggering operation, movement directions corresponding to the respective images comprises:
determining property information corresponding to the respective images; and
determining the movement directions corresponding to the respective images based on the triggering direction of the triggering operation and the property information corresponding to the respective images.

6. The method of claim 2, wherein the plurality of content cards comprise a plurality of target content cards, with an association relationship among the multimedia contents corresponding to the plurality of target content cards, and the plurality of target content cards being adjacent to each other in the target page;
wherein the plurality of target content cards contain a same target foreground image;
wherein target foreground images in the preview information displayed in the plurality of target content cards are region images of different regions of the target foreground image; and
wherein the region images displayed in two adjacent target content cards are adjacent to each other in the target foreground image.

7. The method of claim 6, wherein the determining, based on the triggering operation, movement information corresponding to respective images in the preview information in the respective content cards comprises:
for any of the target content cards,
determining, based on region information of the target foreground image corresponding to the target content card and the triggering operation, foreground movement information corresponding to the target content card, and determining based on the triggering operation, background movement information corresponding to a background image of the target content card; and
wherein the foreground movement information of two adjacent target content cards is the same.

8. The method of claim 1, wherein in accordance with a determination that the preview information displayed in any of the content cards comprises a dynamic image, the method further comprises:
playing the dynamic image, while moving the content card to a target position region of a screen interface.

9-13. (canceled)

14. A computer device, comprising: a processor, a memory, and a bus, the memory having machine-readable instructions stored thereon which are executable by the processor, wherein the processor communicates with the memory through the bus when the computer device is running, and the machine-readable instructions, when executed by the processor, perform acts comprising:
obtaining preview information corresponding to a plurality of multimedia contents, wherein the preview information comprises a plurality of superimposed displayed images;
presenting a plurality of content cards on a target page, wherein the preview information is displayed on the content cards;
in response to a triggering operation on the target page, determining, based on the triggering operation, movement information corresponding to respective images in the preview information in the respective content cards; and
controlling the respective images to be moved based on the corresponding movement information in the respective content cards, while controlling the content cards to be moved based on the triggering operation.

15. The computer device of claim 14, wherein the preview information comprises a background image and at least one foreground image; wherein the at least one foreground image is superimposed on the background image, and the at least one foreground image is superimposed in a predetermined hierarchical order.

16. The computer device of claim 14, wherein the determining, based on the triggering operation, movement information corresponding to respective images in the preview information in the respective content cards comprises:
determining a first movement distance corresponding to the triggering operation; and
for the respective images in the preview information, determining second movement distances corresponding to the respective images based on movement distance calculation modes corresponding to the respective images and the first movement distance.

17. The computer device of claim 16, wherein the determining, based on the triggering operation, movement information corresponding to respective images in the preview information in the respective content cards comprises:
determining, based on a triggering direction of the triggering operation, movement directions corresponding to the respective images; and
wherein the controlling the respective images to be moved based on the corresponding movement information in the respective content cards comprises:
determining a movement time corresponding to the triggering operation;
determining movement speeds corresponding to the respective images based on the movement directions corresponding to the respective images and the movement time; and
controlling, based on the corresponding movement speeds and movement directions, the respective images to be moved for the corresponding movement distances in the respective content cards simultaneously.

18. The computer device of claim 17, wherein the determining, based on a triggering direction of the triggering operation, movement directions corresponding to the respective images comprises:
determining property information corresponding to the respective images; and
determining the movement directions corresponding to the respective images based on the triggering direction of the triggering operation and the property information corresponding to the respective images.

19. The computer device of claim 15, wherein the plurality of content cards comprise a plurality of target content cards, with an association relationship among the multimedia contents corresponding to the plurality of target content cards, and the plurality of target content cards being adjacent to each other in the target page;
wherein the plurality of target content cards contain a same target foreground image;
wherein target foreground images in the preview information displayed in the plurality of target content cards are region images of different regions of the target foreground image; and
wherein the region images displayed in two adjacent target content cards are adjacent to each other in the target foreground image.

20. The computer device of claim 19, wherein the determining, based on the triggering operation, movement information corresponding to respective images in the preview information in the respective content cards comprises:
for any of the target content cards,
determining, based on region information of the target foreground image corresponding to the target content card and the triggering operation, foreground movement information corresponding to the target content card, and
determining based on the triggering operation, background movement information corresponding to a background image of the target content card; and
wherein the foreground movement information of two adjacent target content cards is the same.

21. The computer device of claim 9, wherein in accordance with a determination that the preview information displayed in any of the content cards comprises a dynamic image, the acts further comprise:
playing the dynamic image, while moving the content card to a target position region of a screen interface.

22. A non-transitory computer-readable storage medium, wherein the non-transitory computer-readable storage medium has a computer program stored thereon that, when executed by a processor, performs acts comprising:
obtaining preview information corresponding to a plurality of multimedia contents, wherein the preview information comprises a plurality of superimposed displayed images;
presenting a plurality of content cards on a target page, wherein the preview information is displayed on the content cards;
in response to a triggering operation on the target page, determining, based on the triggering operation, movement information corresponding to respective images in the preview information in the respective content cards; and
controlling the respective images to be moved based on the corresponding movement information in the respective content cards, while controlling the content cards to be moved based on the triggering operation.

23. The non-transitory computer-readable storage medium of claim 22, wherein the preview information comprises a background image and at least one foreground image; wherein the at least one foreground image is superimposed on the background image, and the at least one foreground image is superimposed in a predetermined hierarchical order.

24. The non-transitory computer-readable storage medium of claim 22, wherein the determining, based on the triggering operation, movement information corresponding to respective images in the preview information in the respective content cards comprises:
determining a first movement distance corresponding to the triggering operation; and
for the respective images in the preview information, determining second movement distances corresponding to the respective images based on movement distance calculation modes corresponding to the respective images and the first movement distance.

25. The non-transitory computer-readable storage medium of claim 23, wherein the determining, based on the triggering operation, movement information corresponding to respective images in the preview information in the respective content cards comprises:
determining, based on a triggering direction of the triggering operation, movement directions corresponding to the respective images; and
wherein the controlling the respective images to be moved based on the corresponding movement information in the respective content cards comprises:
determining a movement time corresponding to the triggering operation;
determining movement speeds corresponding to the respective images based on the movement directions corresponding to the respective images and the movement time; and
controlling, based on the corresponding movement speeds and movement directions, the respective images to be moved for the corresponding movement distances in the respective content cards simultaneously.
